(19) United States
(12) Patent Application Publication
(10) Pub. No.: US 2024/0381406 A1
(43) Pub. Date: Nov. 14, 2024

(54) ADAPTIVE SIMULTANEOUS RECEPTION IN IAB NETWORKS

(71) Applicant: Telefonaktiebolaget LM Ericsson (publ), Stockholm (SE)

(72) Inventors: Behrooz MAKKI, Pixbo (SE); Magnus ÅSTRÖM, Lund (SE); Yezi HUANG, Täby (SE); Lei BAO, Göteborg (SE)

(21) Appl. No.: 18/684,220

(22) PCT Filed: Aug. 18, 2021
(86) PCT No.: PCT/SE2021/050812

§ 371 Date: Feb. 16, 2024

(51) Int. Cl. H04W 72/542; H04W 84/04

(52) U.S. Cl. CPC H04W 72/542; H04W 84/047

(57) ABSTRACT

Systems and methods for adaptive simultaneous reception in an Integrated Access and Backhaul (IAB) network are provided. A method performed by an IAB node includes obtaining channel quality or received signal power for each of two or more transmitting nodes at the IAB node and selecting a combination of scheduling configurations for the transmitting nodes based on the channel qualities or received signal powers. The combination of scheduling configurations includes a multiple access scheme for the transmitting nodes selected from a set of multiple access schemes including one or more multiple access schemes that enable simultaneous reception and one or more multiple access schemes that enable non-simultaneous reception. The method further includes transmitting one or more messages to the transmitting nodes that provide information for configuration of or request the transmitting nodes to transmit signals to the IAB node and receiving signals from the transmitting nodes.

### TECHNICAL FIELD

The present disclosure relates to an Integrated Access and Backhaul (IAB) network and, more specifically, simultaneous reception in an IAB node of an IAB network.

### BACKGROUND

Third Generation Partnership Project (3GPP) Fifth Generation (5G) of wireless networks are desired to provide high-rate data streams for everyone everywhere at any time. To meet such demands, 5G networks are required to support large bandwidths. Millimeter wave (mmW)-based links, which may be Multiple Input Multiple Output (MIMO) links, are a key enabler to obtain sufficiently large bandwidths and data rates. Importantly, the wide bandwidths provided by 5G networks makes it possible to include the wireless backhaul transport in the same spectrum as the wireless access. For this reason, an Integrated Access and Backhaul (IAB) network is currently considered as one of the main applications of mmW spectrum. With IAB, a potentially, fiber-connected Access Point (AP), which is referred to as an IAB donor, provides other APs, which are referred to as IAB nodes, and User Equipments (UEs) inside its cell area with wireless backhaul and access connections, respectively. The purpose of IAB is to replace the conventional wired backhaul with a flexible wireless backhaul, where a single IAB node uses the existing 3GPP bands to provide not only backhaul but also existing cellular services. In addition to creating more flexibility, using IAB to provide a flexible, wireless backhaul generally reduces cost as compared using a wired backhaul, which in certain deployments could impose a large cost for installation and operation.

FIG. 1 illustrates one example of an IAB network, where the IAB donor node (in short IAB donor) has a wired connection to the core network and the IAB relay nodes (in short IAB nodes) are wirelessly connected using 3GPP New Radio (NR) to the IAB donor, either directly or indirectly via another IAB node. The connection between IAB donor/node and UEs is called an access link, whereas the connection between two IAB nodes or between an IAB donor and an IAB node is called a backhaul link. For the IAB network, the backhaul links are realized as NR wireless links. An IAB node that provides the upstream backhaul link (towards the IAB donor) is referred to as an IAB parent node whereas an IAB node that connects downstream, away from the IAB donor node, is referred to as an IAB child node.

For a given IAB node, there are six different types of links (see also FIG. 2):
L_{P,DL}: The downlink backhaul link from a IAB parent node (a IAB donor node or another IAB node) to the IAB node (transmitted by the IAB parent node, received by the IAB node).
L_{P,UL}: The uplink backhaul link from the IAB node to the IAB parent node (transmitted by the IAB node, received by the IAB parent node).
L_{C,DL}: The downlink backhaul link from the IAB node to a IAB child node (transmitted by the IAB node, received by the IAB child node).
L_{C,UL}: The uplink backhaul link from an IAB child node to the IAB node (transmitted by the IAB child node, received by the IAB node).
L_{A,DL}: The downlink access link to a UE served by the IAB node (transmitted by the IAB node, received by the UE).
L_{A,UL}: The uplink access link from a UE served by the IAB node (transmitted by the UE, received by the IAB node)

In the initial 3GPP agreements on IAB (Release 16), simultaneous transmission and reception were not considered. However, to reduce the latency of backhaul traffic and to improve the end-to-end (E2E) throughput and delay, it is preferable that the MT function 310-i and DU function 308-i of one IAB node 304-i can receive (or transmit) simultaneously. For this reason, one of the objectives in the Release 17 IAB work item is to provide methods that support simultaneous transmission and reception (see 3GPP RP-193251: “New WID on Enhancements to Integrated Access and Backhaul”). Thus, there is a need for systems and methods for enabling efficient simultaneous reception at an IAB node.

### SUMMARY

Systems and methods for adaptive simultaneous reception in an Integrated Access and Backhaul (IAB) network. In one embodiment, a method performed by an IAB node comprises obtaining channel quality or received signal power for each of two or more transmitting nodes at the IAB node and selecting, based on the channel qualities or received signal powers for the two or more transmitting nodes, a combination of scheduling configurations for the two or more transmitting nodes. The combination of scheduling configurations comprises a multiple access scheme for the two or more transmitting nodes selected from a set of multiple access schemes comprising one or more multiple access schemes that enable simultaneous reception of signals transmitted from the two or more transmitting nodes at the IAB node and one or more multiple access schemes that enable non-simultaneous reception of signals transmitted from the two or more transmitting nodes at the IAB node. The method further comprises transmitting one or more messages to the two or more transmitting nodes that provide information for configuration of or request the two or more transmitting nodes to transmit signals to the IAB node in accordance with the selected multiple access schemes and receiving signals from the two or more transmitting nodes in accordance with the selected multiple access scheme. In this manner, adaptive simultaneous reception in the IAB node is provided.

In one embodiment, the one or more multiple access schemes that enable simultaneous reception of transmissions from the two or more nodes at the IAB node comprise one or more Non-Orthogonal Multiple Access (NOMA) schemes. In one embodiment, the one or more NOMA schemes comprise one or more power-domain NOMA schemes. In one embodiment, the one or more NOMA schemes comprise one or more non-power-domain NOMA schemes. In one embodiment, the one or more multiple access schemes that enable simultaneous reception of transmissions from the two or more nodes at the IAB node further comprise one or more Orthogonal Multiple Access (OMA) schemes. In one embodiment, the one or more OMA schemes comprise: (a) a Spatial Division Multiple Access (SDMA) scheme, (b) a Frequency Division Multiple Access (FDMA) scheme, or (c) both a SDMA scheme and a FDMA scheme.

In one embodiment, the one or more multiple access schemes that enable non-simultaneous reception of transmissions from the two or more nodes at the IAB node comprise one or more OMA schemes that enable non-simultaneous reception. In one embodiment, the one or more OMA schemes that enable non-simultaneous reception comprise a Time Division Multiple Access (TDMA) scheme.

In one embodiment, the two or more transmitting nodes consist of two or more child IAB nodes of the IAB node. In another embodiment, the two or more transmitting nodes consist of two or more wireless communications devices served by the IAB node. In another embodiment, the two or more transmitting nodes consist of one or more child IAB nodes of the IAB node and one or more wireless communications devices served by the IAB node. In another embodiment, the two or more transmitting nodes consist of: a parent IAB node of the IAB node and either (i) one or more child IAB nodes of the IAB node, (ii) one or more wireless communications devices served by the IAB node, or (iii) both (i) and (ii).

In one embodiment, selecting the combination of scheduling configurations for the two or more transmitting nodes comprises selecting the multiple access scheme for the two or more transmitting nodes from the set of multiple access schemes based on the channel qualities or received signal powers for the two or more transmitting nodes at the IAB node.

In one embodiment, selecting the combination of scheduling configurations for the two or more transmitting nodes comprises selecting the multiple access scheme for the two or more transmitting nodes from the set of multiple access schemes based on the received signal powers for the two or more transmitting nodes at the IAB node and a dynamic range of a receiver of the IAB node. In one embodiment, selecting the multiple access scheme for the two or more transmitting nodes comprises determining, based on the received signal powers for the two or more transmitting nodes at the IAB node, whether a combined signal that would result from simultaneous reception of signals from the two or more transmitting nodes at the receiver of the IAB node would exceed the dynamic range of the receiver of the IAB node and, responsive to determining that a combined signal that would result from simultaneous reception of signals from the two or more transmitting nodes at the receiver of the IAB node would not exceed the dynamic range of the receiver of the IAB node, selecting either a power-domain NOMA scheme or a non-power-domain NOMA scheme as the multiple access scheme for the two or more transmitting nodes. In one embodiment, selecting either a power-domain NOMA scheme or a non-power-domain NOMA scheme as the multiple access scheme for the two or more transmitting nodes comprises determining whether a difference in received signal power for the two or more transmitting nodes is greater than a predefined or preconfigured threshold for power-domain NOMA and, responsive to determining that the difference in received signal power for the two or more transmitting nodes is greater than the predefined or preconfigured threshold for power-domain NOMA, selecting a power-domain NOMA scheme as the multiple access scheme for the two or more transmitting nodes. In another embodiment, selecting either a power-domain NOMA scheme or a non-power-domain NOMA scheme as the multiple access scheme for the two or more transmitting nodes comprises determining whether a difference in received signal power for the two or more transmitting nodes is greater than a predefined or preconfigured threshold for power-domain NOMA and, responsive to determining that the difference in received signal power for the two or more transmitting nodes is not greater than the predefined or preconfigured threshold for power-domain NOMA, selecting a non-power-domain NOMA scheme as the multiple access scheme for the two or more transmitting nodes.

In one embodiment, selecting the multiple access scheme for the two or more transmitting nodes comprises determining, based on the received signal powers for the two or more transmitting nodes at the IAB node, whether a combined signal that would result from simultaneous reception of signals from the two or more transmitting nodes at the receiver of the IAB node would exceed the dynamic range of the receiver of the IAB node and, responsive to determining that a combined signal that would result from simultaneous reception of signals from the two or more transmitting nodes at the receiver of the IAB node would exceed the dynamic range of the receiver of the IAB node, selecting a multiple access scheme that enables non-simultaneous reception of signals from the two or more transmitting nodes at the IAB node as the multiple access scheme for the two or more transmitting nodes.

In one embodiment, selecting the multiple access scheme for the two or more transmitting nodes comprises determining, based on the received signal powers for the two or more transmitting nodes at the IAB node, whether a combined signal that would result from simultaneous reception of signals from the two or more transmitting nodes at the receiver of the IAB node would exceed the dynamic range of the receiver of the IAB node. Selecting the multiple access scheme for the two or more transmitting nodes further comprises, responsive to determining that a combined signal that would result from simultaneous reception of signals from the two or more transmitting nodes at the receiver of the IAB node would exceed the dynamic range of the receiver of the IAB node, selecting a multiple access scheme that enables simultaneous reception of signals from the two or more transmitting nodes at the IAB node as the multiple access scheme for the two or more transmitting nodes and configuring or requesting at least one of the two or more transmitting nodes to adjust its transmit power such that a combined signal that would result from simultaneous reception of signals from the two or more transmitting nodes at the receiver of the IAB node would not exceed the dynamic range of the receiver of the IAB node.

In one embodiment, selecting the multiple access scheme for the two or more transmitting nodes comprises determining whether the two or more transmitting nodes are IAB nodes and, responsive to determining that the two or more transmitting nodes are IAB nodes, determining whether a gain of NOMA-based transmission for the two or more transmitting nodes exceeds a predefined or preconfigured threshold and, responsive to determining that the gain of NOMA-based transmission for the two or more transmitting nodes exceeds the predefined or preconfigured threshold, selecting a power-domain NOMA scheme as the multiple access scheme for the two or more transmitting nodes.

In one embodiment, selecting the multiple access scheme for the two or more transmitting nodes comprises determining whether the two or more transmitting nodes are IAB nodes and, responsive to determining that the two or more transmitting nodes are IAB nodes, determining whether a gain of NOMA-based transmission for the two or more transmitting nodes exceeds a predefined or preconfigured threshold. The selecting further comprises, responsive to determining that the gain of NOMA-based transmission for the two or more transmitting nodes does not exceed the predefined or preconfigured threshold, selecting a multiple access scheme other than a power-domain NOMA scheme as the multiple access scheme for the two or more transmitting nodes.

In one embodiment, selecting the multiple access scheme for the two or more transmitting nodes comprises determining whether the two or more transmitting nodes include both an IAB node and a UE and, responsive to determining that the two or more transmitting nodes include both an IAB node and a UE, determining whether simultaneous reception of signals from the two or more transmitting nodes is allowed based on the channel qualities or received channel strengths for the two or more transmitting nodes. The selecting further comprises, responsive to determining that simultaneous reception of signals from the two or more transmitting nodes is allowed, selecting a non-power-domain NOMA scheme as the multiple access scheme for the two or more transmitting nodes.

In one embodiment, selecting the multiple access scheme for the two or more transmitting nodes comprises determining whether the two or more transmitting nodes include both an IAB node and a UE and, responsive to determining that the two or more transmitting nodes include both an IAB node and a UE, determining whether simultaneous reception of signals from the two or more transmitting nodes is allowed based on the channel qualities or received channel strengths for the two or more transmitting nodes. The selecting further comprises, responsive to determining that simultaneous reception of signals from the two or more transmitting nodes is not allowed, selecting TDMA scheme as the multiple access scheme for the two or more transmitting nodes.

In one embodiment, selecting the multiple access scheme for the two or more transmitting nodes comprises determining whether the two or more transmitting nodes are two or more UEs served by the IAB node and, responsive to determining that the two or more transmitting nodes are two or more UEs served by the IAB node, selecting a multiple access scheme from the set of multiple access schemes for which a performance metric exceeds that of the other multiple access schemes in the set of multiple access schemes with respect to the two or more transmitting nodes.

Corresponding embodiments of an IAB node are also disclosed. In one embodiment, an IAB node is adapted to obtain channel quality or received signal power for each of two or more transmitting nodes at the IAB node and select, based on the channel qualities or received signal powers for the two or more transmitting nodes, a combination of scheduling configurations for the two or more transmitting nodes. The combination of scheduling configurations comprises a multiple access scheme for the two or more transmitting nodes selected from a set of multiple access schemes comprising one or more multiple access schemes that enable simultaneous reception of signals transmitted from the two or more transmitting nodes at the IAB node and one or more multiple access schemes that enable non-simultaneous reception of signals transmitted from the two or more transmitting nodes at the IAB node. The IAB node is further adapted to transmit one or more messages to the two or more transmitting nodes that provide information for configuration of or request the two or more transmitting nodes to transmit signals to the IAB node in accordance with the selected multiple access scheme and receive signals from the two or more transmitting nodes in accordance with the selected multiple access scheme.

In one embodiment, an IAB node comprises processing circuitry configured to cause the IAB node to obtain channel quality or received signal power for each of two or more transmitting nodes at the IAB node and select, based on the channel qualities or received signal powers for the two or more transmitting nodes, a combination of scheduling configurations for the two or more transmitting nodes. The combination of scheduling configurations comprises a multiple access scheme for the two or more transmitting nodes selected from a set of multiple access schemes comprising one or more multiple access schemes that enable simultaneous reception of signals transmitted from the two or more transmitting nodes at the IAB node and one or more multiple access schemes that enable non-simultaneous reception of signals transmitted from the two or more transmitting nodes at the IAB node. The processing circuitry is further configured to cause the IAB node to transmit one or more messages to the two or more transmitting nodes that provide information for configuration of or request the two or more transmitting nodes to transmit signals to the IAB node in accordance with the selected multiple access scheme and receive signals from the two or more transmitting nodes in accordance with the selected multiple access scheme.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of an Integrated Access and Backhaul (IAB) network;

FIG. 2 illustrates the different types of links in an IAB network;

FIG. 3 illustrates one example of an IAB network in which embodiments of the present disclosure may be implemented;

FIG. 4 is a flow chart that illustrates the operation of an IAB node to adaptively perform simultaneous reception at a receiver of the IAB node from two or more transmitting nodes in accordance with embodiments of the present disclosure;

FIG. 5 is a flow chart that illustrates the details of one example embodiment of step 404-1 of FIG. 4 in which the IAB node selects the multiple access scheme for the two or more transmitting nodes based on the dynamic range of the receiver of the IAB node;

FIG. 6 is a flow chart that illustrates the details of one example embodiment of step 404-1 of FIG. 4 in which the IAB node selects the multiple access scheme for the two or more transmitting nodes based on the node types of the transmitting nodes;

FIG. 7 illustrates an example embodiment of the present disclosure;

FIG. 8 is a schematic block diagram of an IAB node according to some embodiments of the present disclosure; and

FIG. 9 is a schematic block diagram of the IAB node of FIG. 8 according to some other embodiments of the present disclosure.

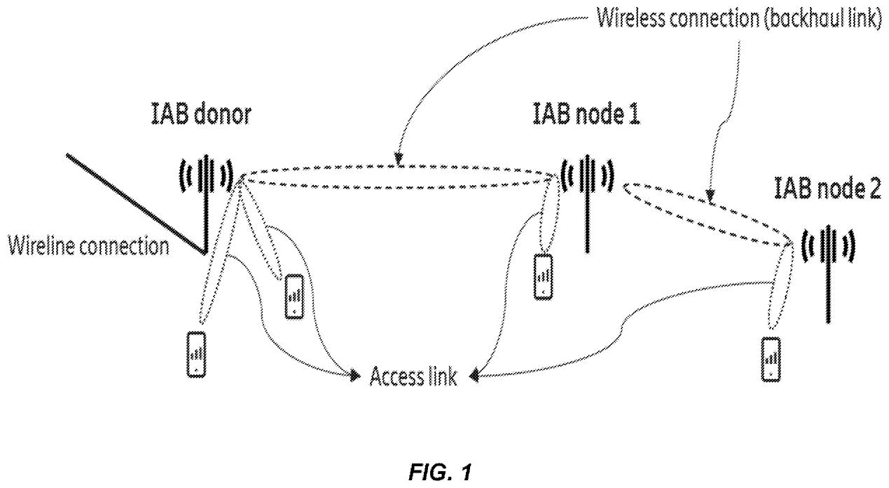

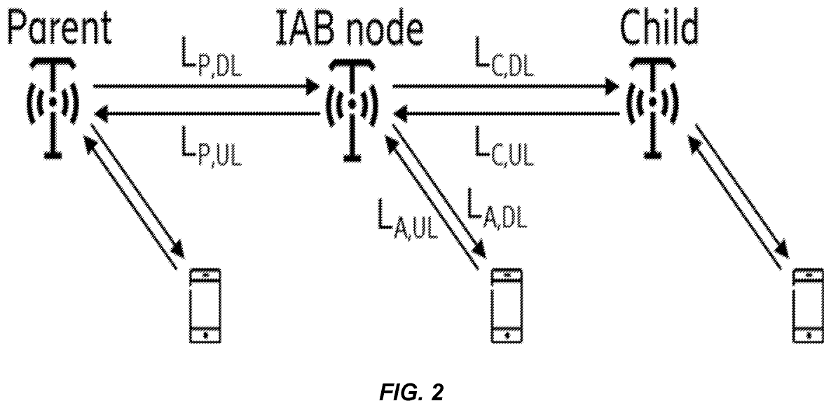

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

IAB Node: As used herein, an Integrated Access and Backhaul (IAB) node is a RAN node that supports wireless access to UEs and wirelessly backhauls the access traffic.

IAB Donor Node: As used herein, an IAB donor node or IAB donor is a node that connects to the core network (e.g., via wired connection such as, e.g., a fiber connection). The IAB donor includes a Central Unit (CU). Note that an IAB donor node may also be an IAB node. For instance, a donor IAB node is a parent IAB node.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

Currently, there are issues related to simultaneous reception at an IAB node. Although simultaneous reception of signals from different transmitting nodes is accepted in IAB networks, there is still no efficient method to enable simultaneous signal reception due to, e.g., the very different dynamic ranges that may occur when simultaneously receiving both an IAB transmission and a UE transmission or only one of them. This may result in different reception conditions and consequently, opportunities or needs to use different receiver schemes.

Particularly, as we explain in the following, IAB networks have specific characteristics which make it possible to develop smart simultaneous signal reception procedures. This leads to an improved performance when simultaneously receiving weak and strong signals as well as to higher spectral efficiency/network throughput.

Systems and methods are disclosed herein for adaptive simultaneous signal reception in an IAB network. Embodiments of the present disclosure may increase spectral efficiency, as well as improve the reliability for low Signal-to-Noise Ratio (SNR) signals. In one embodiment, if two or more nodes request for connection to an IAB node simultaneously, the IAB node determines an appropriate combination of scheduling configurations for the two or more nodes based on, e.g., channel quality, received signal power, and/or other information. The IAB node transmits control message(s) to the two or more node to provide information for configuration of or request that the nodes operate in accordance with the determined combination of scheduling configurations. Based on the determined combination of scheduling configurations, the IAB node receives signals from the two or more nodes and, in some embodiments, may adapt its decoding and/or timing correspondingly.

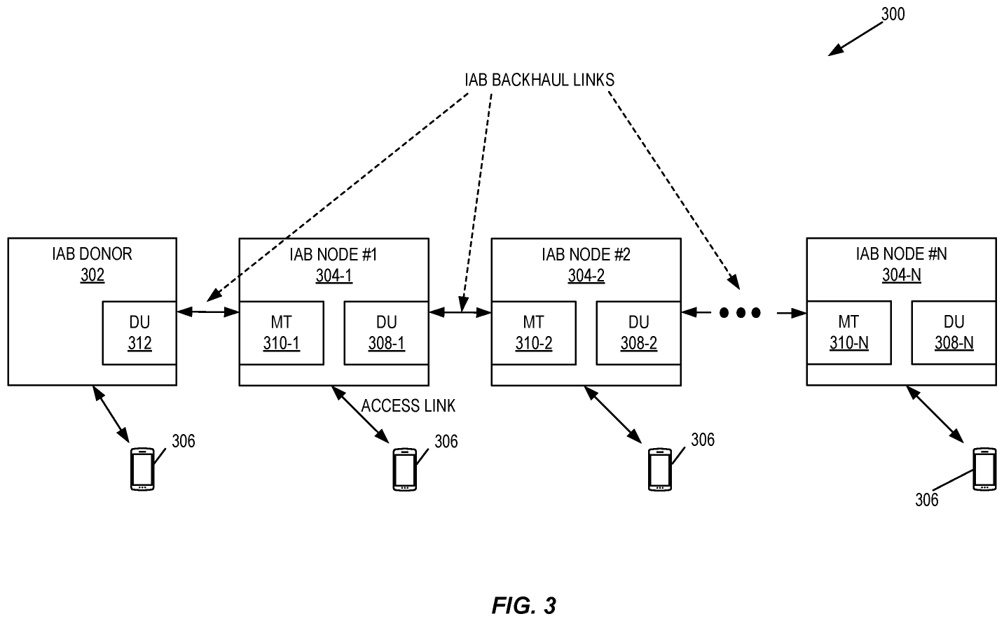

FIG. 3 illustrates one example of a multi-hop IAB network 300 in which embodiments of the present disclosure may be implemented. The multi-hope IAB network 300 includes an IAB donor node 302 and a number of IAB nodes 304-1 through 304-N (generally referred to herein collectively as IAB nodes 304 and individually as IAB node 304-i). The IAB donor 302 and the IAB nodes 304 provide wireless access to UEs 306 in their respective cells. Each IAB node 304-i in the chain of the nodes acts as child IAB node towards an upstream IAB node 304-(i−1) and acts as a parent IAB node towards one or more downstream IAB nodes 304-(i+1). For ease notation, a parent IAB node is denoted herein as parent IAB node 304-p, and a child IAB node is denoted herein as child IAB node 304-c. Note that the IAB donor 302 also acts a parent IAB node to the IAB node 304-1. Further note that while the example of FIG. 3 shows at most one child IAB node 304-c for each IAB node 304-i and for the IAB donor 302, the IAB nodes 304-i and the IAB donor 302 may each have one or more child IAB nodes. The IAB donor 302 is the only node connected to the core network (not shown) via a wired connection, e.g., via a fiber connection. Each IAB node 304-i is wirelessly connected to the core network in a multi-hop fashion.

Each IAB node 304-i contains a Distributed Unit (DU) function 308-i and a Mobile Termination (MT) function 310-i. Through the MT function 310-i, the IAB node 304-i connects to its parent IAB node 304-p or the IAB donor 302. Through the DU function 308-i, the IAB node 304-i connects to UEs 306 and the MT function(s) 310 of its child IAB node(s) 304-c. That is, the MT function 310-i of the IAB node 304-i is responsible for the backhaul communication to the parent IAB DU 308-p of its parent IAB node 304-p. The IAB DU 308-i of the IAB node 304-i is responsible for both UE access (both uplink and downlink) and backhaul to the MT function 310-c of its child IAB node 304-c (both downlink and uplink). Note that the IAB donor 302 includes an DU function 312.

The present disclosure focuses on the case of simultaneous reception at an IAB node 304-i. Here, the IAB node 304-i may at the same time (i.e., simultaneously) receive signals from a UE(s) 306 on the wireless access uplink, its parent IAB node 304-p or IAB donor 302 on the wireless backhaul downlink, and/or its child IAB node(s) 304-c on the wireless backhaul uplink(s). As an example, the DU function 308-i of the IAB node 304-i may simultaneously receive signals from a UE 306 on the wireless access uplink and its child IAB node 304-c on the wireless backhaul uplink. In another example, the MT function 310-i and the DU function 308-i of the IAB node 304-i may simultaneously receive signals from its parent IAB node 304-p on the wireless backhaul downlink and a UE 306 on the wireless access uplink using the same receiver. For this reason, in the following, we do not differentiate between the DU and MT functions 308-i and 310-i, and discuss the IAB node 304-i in general.

Generally, such simultaneous reception scenarios represent a Non-Orthogonal Multiple Access (NOMA) scheme. With NOMA, a two (or more) nodes are co-scheduled and share the same radio resources in time, frequency, and/or code. A large number of non-power-domain NOMA scheme, such as Sparse Code Multiple Access (SCMA), Resource Spread Multiple Access (RSMA), Multi-User Shared Access (MUSA), Welch-bound equality Spread Multiple Access (WSMA), etc. have been proposed for NOMA (see, e.g., Makki et al., “A Survey of NOMA: Current Status and Open Research Challenges,” Digital Object Identifier, Vol. 1, pages 179-189, Jan. 28, 2020 (hereinafter “Makki”) for the definition and performance of these non-power-domain NOMA schemes). These techniques generally follow the superposition principle and, along with differences in bit- and symbol-level NOMA implementation, the main difference among them is the nodes' signature design which is based on spreading, coding, scrambling, or interleaving distinctness.

The non-power-domain NOMA schemes are useful for the cases with, e.g., uplink NOMA from UEs to base stations where (1) the UEs are not much capable of power allocation and (2) the UEs do not have accurate power control. On the other hand, it can be theoretically shown that power-domain NOMA, in which the paired nodes send the data with different powers and the receiver performs successive interference cancellation (SIC)-based decoding, gives the best performance of NOMA. This, however, requires the paired nodes to have accurate and high power control capability.

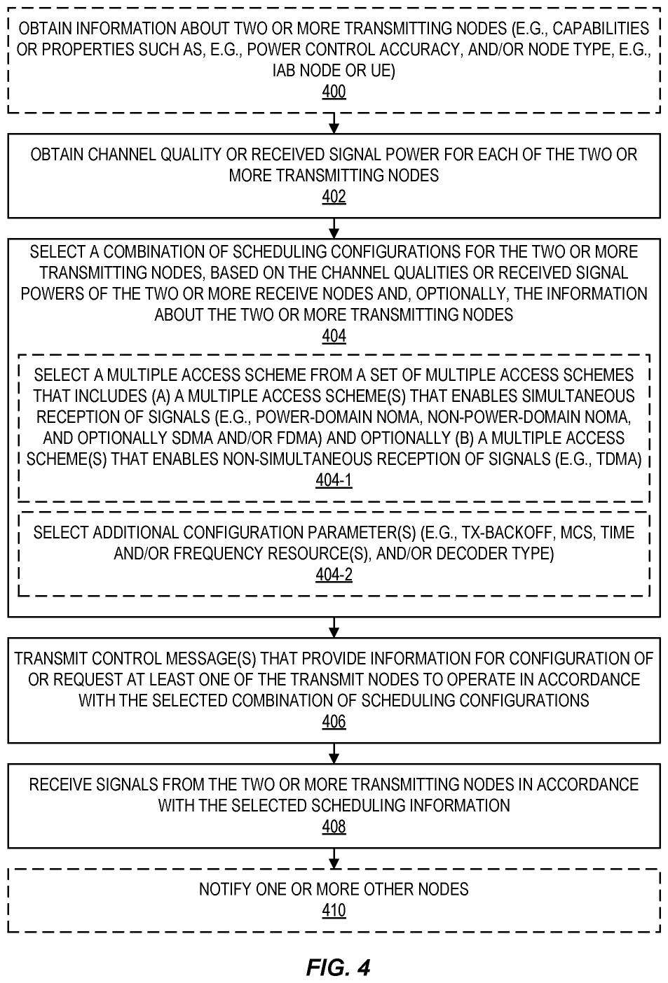

FIG. 4 is a flow chart that illustrates the operation of an IAB node 304-i to adaptively perform simultaneous reception at a receiver of the IAB node 304-i from two or more transmitting nodes in accordance with embodiments of the present disclosure. Note that optional steps are represented in FIG. 4 using dashed lines/boxes. The two or more transmitting nodes may be either: (a) two or more IAB nodes (e.g., the parent IAB node 304-p and one or more child IAB nodes 304-c, or two or more child IAB nodes 304-c), (b) two or more UEs 306 served by the IAB node 304-i, or (c) both one or more IAB nodes and one or more UEs 306.

As illustrated, the IAB node 304-i may obtain information about the two or more transmitting nodes (step 400). This information may include information about one or more capabilities of the transmitting nodes that related to simultaneous reception of signals from the transmitting nodes at the IAB node 304-i such as, e.g., a transmit power control accuracy of the transmitting nodes. The information about the transmitting nodes may include a node type (i.e., IAB node or UE) of the transmitting nodes. Note that the IAB node 304-i may obtain the information about the transmitting nodes in any desired manner. For example, capability information may be obtained via singling from the transmitting nodes. As another example, the node type may be determined based on information related to a random access procedure utilized by the transmitted nodes (e.g., random access preamble used or random access resources used, where different types of nodes use different random access preambles or different random access resources).

The IAB node 304-i obtains a channel quality or received signal power for each of the two or more transmitting nodes (402). The channel quality is a metric that indicates a quality of a radio channel between the respective transmitting node and the IAB node 304-i. The received signal power is the power level of a signal transmitted by the transmitting node when received at the IAB node 304-i. For example, the received signal power may be the total receive power, which may depend on multiple parameters such as transmission power per subcarrier, number of subcarriers on which the signal is transmitted, and channel attenuation. Optionally based on the obtained information about two or more transmitting nodes and based on the obtained channel quality or received signal power for each of the two or more transmitting nodes, the IAB node 304-i may determine a set of multiple access schemes comprising one or more multiple access schemes that enable simultaneous reception of signals transmitted from the two or more transmitting nodes at the IAB node (304-i) and one or more multiple access schemes that enable non-simultaneous reception of signals transmitted from the two or more transmitting nodes at the IAB node (304-i).

The IAB node 304-i selects a combination of scheduling configurations for the two or more transmitting nodes based on the channel qualities or received signal powers of the transmitting nodes and, optionally, the information about the transmitting nodes (step 404). In one embodiment, the combination of scheduling configurations includes a multiple access scheme, and the IAB node 304-i selects a multiple access scheme for the two or more transmitting nodes from a set of multiple access schemes that includes one or more (or two or more) multiple access schemes that enable simultaneous reception of signals from the two or more transmitting nodes and, in some embodiments, one or more multiple access schemes that enable non-simultaneous reception of signals from the two or more transmitting nodes. As used herein, “simultaneous reception” of signals from two or more transmitting nodes refers to reception of signals from the two or more transmitting nodes on the same time-domain resources. Examples of multiple access schemes that enable simultaneous reception are NOMA, SDMA, and FDMA. The one or more multiple access schemes that enable simultaneous reception included in the set from which the multiple access scheme for the two or more transmitting nodes is selected includes one or more NOMA schemes such as, e.g., one or more power-domain NOMA schemes and one or more non-power-domain NOMA schemes and, in some embodiments, one or more SDMA schemes and/or one or more FDMA schemes. Conversely, as used herein, “non-simultaneous reception” of signals from two or more transmitting nodes refers to the reception of signals from the two or more transmitting nodes on different time-domain resources. An example of a multiple access scheme that enables non-simultaneous reception is TDMA. Thus, the one or more multiple access schemes that enable non-simultaneous reception included in the set from which the multiple access scheme for the two or more transmitting nodes is selected includes one or more TDMA schemes.

In addition to the selected multiple access scheme, in one embodiment, the IAB node 304-i selects on or more additional parameters for the selected combination of scheduling configurations (step 404-2). The one or more additional parameters may include, e.g., a Modulation and Coding Scheme (MCS), a transmit power level (e.g., a transmit (TX) back-off level), time and/or frequency resource, decoder type, transmit beam (or transmit precoder), and/or the like).

The IAB node 304-i transmits one or more messages that provide information for configuration of or request the transmit nodes at least one of the two or more transmit nodes to operate in accordance with the selected scheduling configuration (step 406). For example, if a particular transmitting node is a UE 306 or a child IAB node 304-c of the IAB node 304-i, the IAB node 304-i transmits one or more control messages to the UE 306 or child IAB node 304-c to configure the UE 306 or child IAB node 304-c to transmit on the uplink access/backhaul link in accordance with the selected combination of scheduling configurations. As another example, if a particular transmitting node is a parent IAB node 304-p of the IAB node 304-i, the IAB node 304-i transmits one or more control messages to the parent IAB node 304-p to request that the parent IAB node 304-p transmit to the IAB 304-i on the downlink backhaul link in accordance with the selected combination of scheduling configurations. Notably, in this case, the parent IAB node 304-p is performing the actual scheduling of the transmission on the downlink backhaul link to the IAB node 304-i, but the IAB node 304-i is requesting that the parent IAB node 304-p schedules this transmission in a particular way (i.e., in accordance with the selected combination of scheduling configurations at the IAB node 304-i, which either enables simultaneous reception at the IAB node 304-i or not in an adaptive manner depending on the selection of step 404). The parent IAB node 304-p may choose to either accept the request or reject the request from the IAB node 304-i.

The IAB node 304-i then receives signals from the two or more transmitting nodes in accordance with the selected combination of scheduling configurations (step 408). This may include, in some embodiments, adjusting a decoder of the IAB node 304-i and/or a timing of the IAB node 304-i.

The IAB node 304-i may also notify one or more other nodes (step 410). For example, if the IAB-node 304-i needs an approval from the parent IAB node 304-p, upon receiving an approval from the parent IAB node 304-p, the IAB node 304-i may notify the child IAB node(s) 304-c to adjust transmission parameters accordingly.

In regard to the selection of the combination of scheduling configurations in step 404, from a received signal power perspective, the two following situations may occur:
The received signal powers from the two transmitting nodes are similar (i.e., within a predefined or preconfigured range of one another), which is expected when, e.g., both transmitting nodes are (similar) IAB nodes. In this case, in one embodiment, the selected multiple access scheme is a non-power domain NOMA scheme or may alternatively be SDMA, FDMA, or TDMA, depending on other criteria such as, e.g., which of these multiple access schemes will provided a best performance, e.g., in terms of a performance metric (e.g., throughput).
The received signal powers from the two transmitting nodes different (i.e., not within the predefined or preconfigured range of one another). This may be because, for example, one transmitting node is an IAB node and the other transmitting node is a UE 306. In this case, in one embodiment, the IAB node 304-i may select the multiple access scheme for the combination of scheduling configurations as follows:
   If the difference in the received signal powers is larger than a dynamic range of a receiver of the IAB node 304-i, which as used herein may be an absolute dynamic range of the receiver of the IAB node 304-i or may be a predefined dynamic range specified for evaluation for the receiver of the IAB node 304-i to determine the multiplexing scheme, the IAB node 304-i either:
      Selects a NOMA scheme (e.g., non-power-domain NOMA scheme) and decreases the difference in the received signal powers by, e.g., configuring or requesting (e.g., in step 406) at least one of the transmitting nodes to adjust its transmit power; or
      Selects an OMA scheme (e.g., TDMA) such that the transmitting nodes are not scheduled simultaneously in the time-domain (e.g., if the difference in the received signal powers cannot be decreased, e.g., because the at least one of the transmitting nodes does not agree to adjust its transmit power).
   If the difference in the received signal powers is smaller than the dynamic range of the receiver of the IAB node 304-i but sufficiently large to utilize special, power-domain NOMA, the IAB node 304-i selects the power-domain NOMA (e.g., if the transmitting nodes have sufficient transmit power accuracy).

From a signaling perspective, two different situations may occur:
In one scenario, both transmitting nodes are child IAB nodes 304-c of the IAB node 304-i. In this case, in one embodiment, the IAB node 304-i schedules both transmitting nodes for simultaneous reception at the IAB node 304-i. In other words, a multiple access scheme that enables simultaneous reception is selected.
In another scenario, one of the transmitting nodes is a parent IAB node 304-p of the IAB node 304-i, and another transmitting node is either a child IAB node of the IAB node 304-i or a UE 306 served by the IAB node 304-i. In this case, in one embodiment, the IAB node 304-i may schedule the transmitting nodes for non-simultaneous reception at the IAB node 304-i. In other words, a multiple access scheme that enables non-simultaneous reception is selected. In this case, since the parent IAB node 304-p is one of the transmitting nodes, the IAB node 304-i may send a request for the desired scheduling to the parent IAB node 304-p and proceed accordingly once approval is received from the parent IAB node 304-p.

From a transmit power accuracy perspective, two different situations may occur:
In one scenario, both transmitting nodes have a high transmit power accuracy, sufficient to efficiently utilize power-domain NOMA. In this case, the IAB node 304-i may select a power-domain NOMA as the multiple access scheme for the transmitting nodes.
In another scenario, at least one of the transmitting nodes is not sufficiently accurate to utilize power-domain NOMA. In this case, the IAB node 304-i may select, e.g., a non-power domain NOMA scheme or other multiple access scheme (e.g., SDMA, FDMA, or TDMA may also be considered).

Thus, embodiments of the present disclosure consider different receive signal power situations, signaling situations, and transmit power accuracy situations when selecting the combination of scheduling configurations for the transmitting nodes, e.g., such that network capacity is maximized for each combination of the above situations. Further details are provided below.

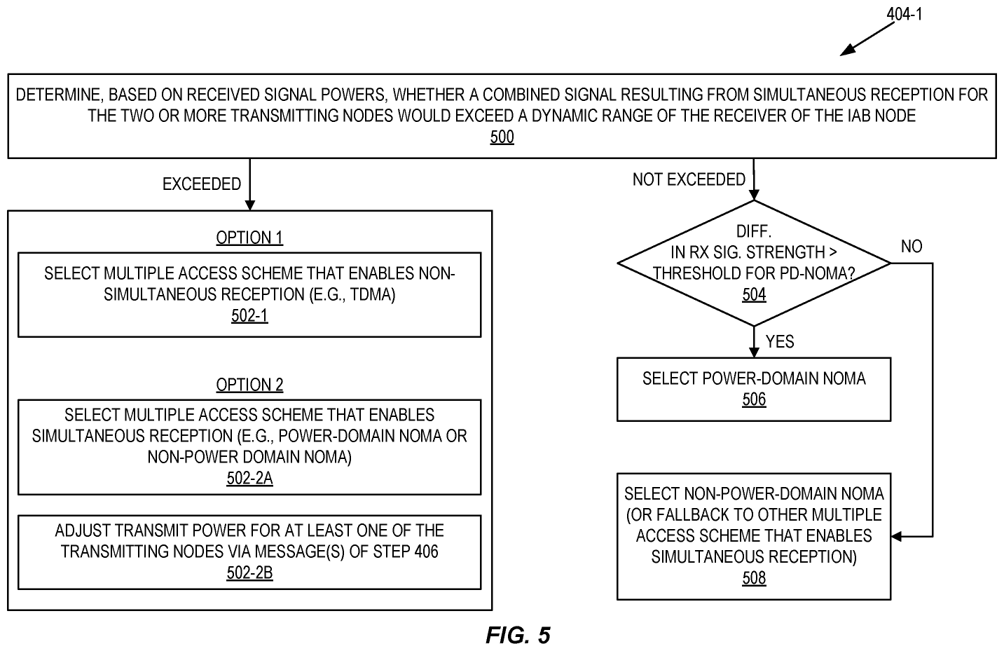

In some embodiments, the dynamic range of the receiver of the IAB node 304-i is considered together with the received signal powers of the two or more transmitting nodes when selecting the combination of scheduling configurations, and more specifically the multiple access scheme, in step 404 of the process of FIG. 4. In this regard, FIG. 5 is a flow chart that illustrates the details of one example embodiment of step 404-1 of FIG. 4 in which the IAB node 304-i selects the multiple access scheme for the two or more transmitting nodes based on the dynamic range of the receiver of the IAB node 304-i. As illustrated, the IAB node 304-i determines, based on the received signal powers for the two or more transmitting nodes, whether a combined signal that would result from simultaneous reception of signals from the two or more transmitting nodes would exceed the dynamic range of the receiver of the IAB node 304-i (step 500). If the dynamic range of the receiver of the IAB node 304-i would be exceeded, the IAB node 304-i may operate in accordance with either of two options, which are denoted here as “Option 1” and “Option 2”. For Option 1, the IAB node selects a multiple access scheme (e.g., TDMA) that enables non-simultaneous reception at the IAB node 304-i (step 502-1). For Option 2, the IAB node 304-i alternatively selects a multiple access scheme (e.g., a NOMA scheme) that enables simultaneous reception at the IAB node 304-i (step 502-2A) and provide information for configuration ofs or instructs at least one of the transmitting nodes (in step 406 of FIG. 4) to adjust its transmit power to reduce the difference in received signal powers such that the dynamic range of the receiver of the IAB node 304-i will not be exceeded during simultaneous reception from the two or more transmitting nodes at the IAB node 304-i (step 502-2B). This may occur by the IAB node 304-i transmitting a control message requesting the transmit power to be either decreased (to the stronger transmitting node) or increased (to the weaker transmitting node).

In regard to the signaling of step 502-2B (and thus step 406 of FIG. 4), for a child IAB node 304-c or UE 306, the signaling may take place as a part of a scheduling message sent by the IAB node 304-i to schedule the respective transmission. For a parent IAB node 304-p, the signaling may take place as a power control requesting message. Note that the IAB node 304-i cannot control the transmit power of its parent IAB node 304-p; however, it may still request a certain transmit power from the parent IAB node 304-p. In this case, in one embodiment, the IAB node 304-i does not select the multiple access scheme that enables simultaneous reception in step 502-2B until the parent IAB node 304-p sends a response that indicates that the requested power adaptation can be fulfilled. In either case, the power control requesting message may request a change to transmit bandwidth and/or subcarrier transmit power. The power control requesting message may additionally or alternatively request an indirect change of the transmit power, e.g., by changing the number of antenna elements in the transmission or precoding weights of the antenna elements.

Returning to step 500, if the IAB node 304-i determines that a combined signal that would result from simultaneous reception of signals from the two or more transmitting nodes would not exceed the dynamic range of the receiver of the IAB node 304-i, the IAB node 304-i determines with the difference in the received signal powers for the transmitting nodes is greater than a predefined or preconfigured threshold for power-domain NOMA (step 504). If the difference in the received signal powers for the transmitting nodes is greater than the predefined or preconfigured threshold for power-domain NOMA, the IAB node 304-i selects a power-domain NOMA scheme as the multiple access scheme for the transmitting nodes (step 506). Note that the selection in step 506 may, in some embodiments, require satisfaction of one or more additional criteria (e.g., the transmitting nodes are all IAB nodes, the transmitting nodes all have power control accuracy sufficient for power-domain NOMA, and/or the like). If these criteria are not also satisfied, the IAB node 304-i may select some other multiple access scheme (e.g., SDMA, FDMA, or TDMA). If power-domain NOMA is selected, the beamforming of the transmitting nodes may also be adapted accordingly. If the difference in the received signal powers for the transmitting nodes is not greater than the predefined or preconfigured threshold for power-domain NOMA, the IAB node 304-i selects, in this example, a non-power-domain NOMA scheme (step 508). Note that the selection in step 508 may, in some embodiments, require satisfaction of one or more additional criteria. Further, other multiple access schemes (e.g., SDMA, FDMA, and/or TDMA) may also be considered where the multiple access scheme providing the best performance (e.g., in terms of throughput) may be selected.

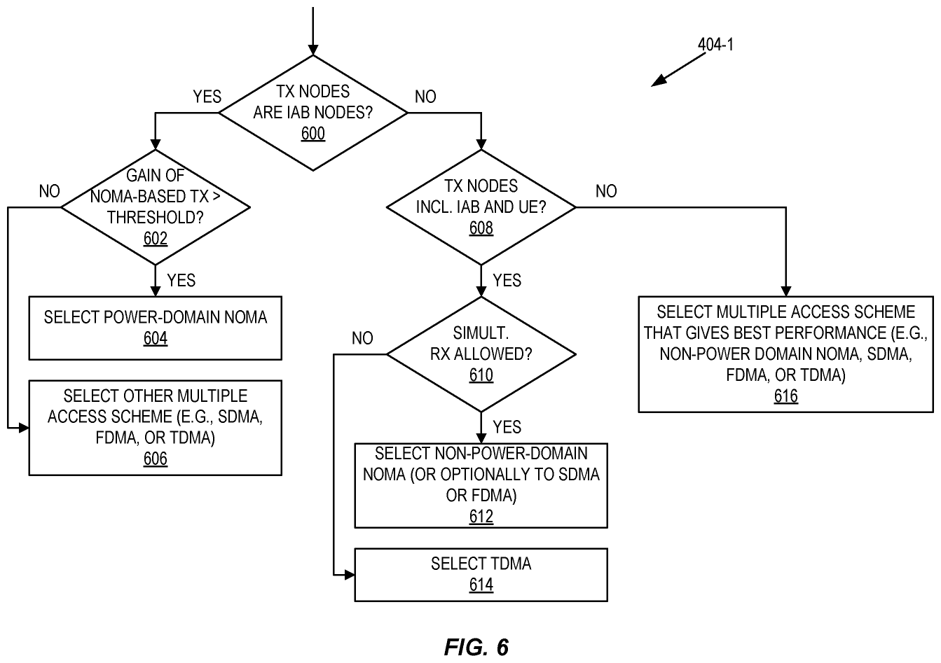

In some embodiments, the node type of each of the transmitting nodes is considered when selecting the combination of scheduling configurations, and more specifically the multiple access scheme, in step 404 of the process of FIG. 4. In this regard, FIG. 6 is a flow chart that illustrates the details of one example embodiment of step 404-1 of FIG. 4 in which the IAB node 304-i selects the multiple access scheme for the two or more transmitting nodes based on the node types of the transmitting nodes. As illustrated, the IAB node 304-i determines whether the transmitting nodes are all IAB nodes (step 600). If so, the IAB node 304-i determines whether a gain from using a NOMA scheme is greater than a predefined or preconfigured threshold (step 602). If so, the IAB node 304-i selects a power-domain NOMA scheme (step 604). Otherwise, the IAB node 304-i selects another multiple access scheme (e.g., SDMA, FDMA, or TDMA) (step 606).

Returning to step 600, if the transmitting nodes are not all IAB nodes, the IAB node 304-i determines whether the transmitting nodes include both an IAB node(s) and a UE(s) 306 (step 608). If so, the IAB node 304-i determines whether simultaneous reception of signals from the transmitting nodes at the receiver of the IAB node 304-i is allowed (step 610). In one embodiment, this determination is based on the received signal powers of the transmitting nodes and the dynamic range of the receiver of the IAB node 304-i, e.g., in a manner similar to what is described above with respect to FIG. 5 (e.g., if the dynamic range would not be exceeded, then simultaneous reception is allowed; otherwise, it is not allowed). If simultaneous reception is allowed, the IAB node 304-i selects a non-power-domain NOMA scheme as the multiple access scheme (step 612). Optionally, the IAB node 304-i may fallback to another multiple access scheme (e.g., SDMA, FDMA, or TDMA) if better performance would be achieved. If NOMA-based simultaneous reception is not allowed, the IAB node 304-i, in this example, selects TDMA (alternatively SDMA or FDMA) (step 614).

Returning to step 608, if the transmitting nodes do not include both an IAB node(s) and a UE(s) (i.e., if the transmitting nodes are all UEs), the IAB node 304-i selects a multiple access scheme that gives a best performance (e.g., with respect to a predefined or preconfigured performance metric such as, e.g., throughput) (step 616).

In the embodiments described herein, two signaling situations may affect the decision of the IAB node 304-i in regard to the selection of the combination of scheduling configurations of the transmitting nodes. In the case where all transmitting nodes are child IAB nodes 304-c of the IAB node 304-i, the IAB node 304-i may singlehandedly determine the combination of scheduling configurations for the transmitting nodes. That is, the IAB node 304-i may (within limits) determine on its own the preferred transmission scheme, e.g., the dynamic range of the two nodes. Furthermore, following transmission of a scheduling grant, the IAB node 304-i can expect the scheduled transmission to occur.

The above is different from the case where one of the transmitting nodes is a parent IAB node 304-p of the IAB node 304-i, in which case the parent IAB node 304-p will schedule the downlink transmission to the IAB node 304-i, and the IAB node 304-i will subsequently need to adapt to the scheduling of the parent IAB node 304-p when it schedules its child IAB nodes 304-c. Possibly, the second situation may include a transmit power back-off request by the IAB node 304-i to the parent IAB node 304-p such that it limits its transmit power in its transmission, thereby reducing the dynamic range of the two transmitting nodes, but it is still not certain the parent IAB node 304-p will grant the request-a feedback response from the parent IAB node 304-p indicating whether the requested change is granted or not is needed in some embodiments. In this case, there is also the possibility that the parent IAB node 304-p does not grant the back-off request, in which case the reception from the child IAB node 304-c may be lost completely. Such a missed reception may require a complete retransmission of the previously transmitted data instead of transmitting incremental redundancy bits as is usually the case with a missed reception.

Another situation may consider the accuracy of the transmit power levels of the two transmitting nodes when selecting the combination of scheduling configurations, and in particular the multiple access scheme. In the case in which all of the transmitting nodes have a high accuracy (e.g., accuracy above a predefined or preconfigured level), which may be the case if, for example, if the transmitting nodes are IAB nodes, power-domain NOMA may be used. Conversely, if one of the transmitting nodes has a power control accuracy that is too low (e.g., less than a predefined or preconfigured minimum threshold for power-domain NOMA), non-power domain NOMA may be preferred. The different alternatives may also include using different reception techniques, corresponding to the different transmission techniques. For example, using the power-domain NOMA transmission scheme, would imply that the reception of the weaker signal would use successive interference cancellation when receiving the weaker signal.

Furthermore, there is a risk that the IAB node 304-i mistakes what technique to use during reception. Here too that would imply that a missed packet will not be corrected by additional redundancy bits, but a complete retransmission would be required. In that case, a specific indicator could be used for such a case.

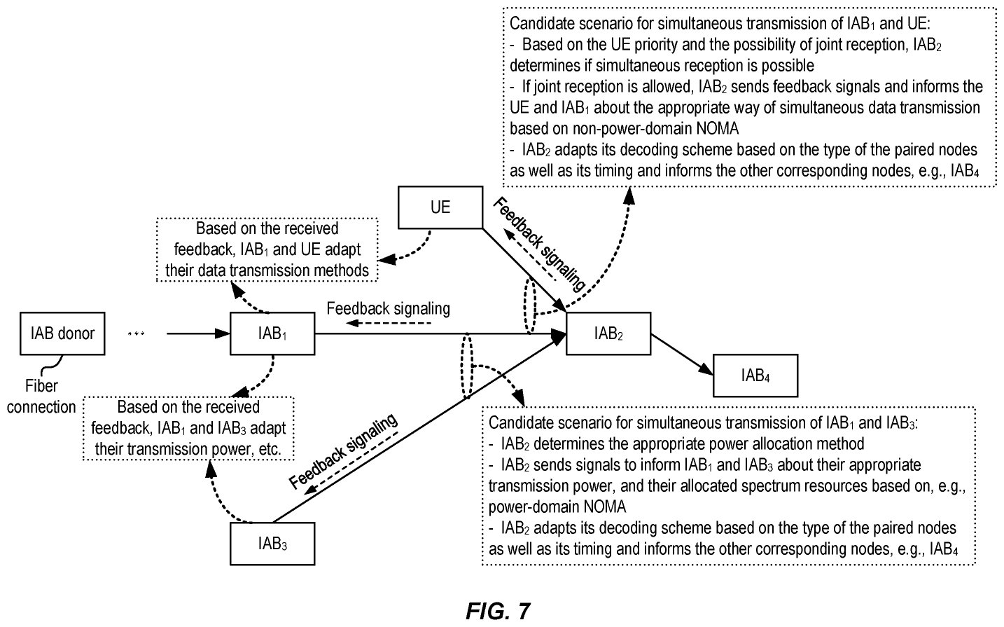

FIG. 7 illustrates one example of the IAB network 300. In this example, IAB node (IAB₂) is the IAB node 304-i. In one example, the transmitting nodes are IAB₁ and UE. In this example, based on UE priority and the possibility of simultaneous reception, IAB₂ determines whether simultaneous reception is possible. If so, IAB₂ sends control signals to provide information for configuration of/request the UE and IAB₁ to operate in the appropriate way for simultaneous reception of their transmitted signals at IAB₂ based on non-power-domain NOMA. IAB₂ adapts its decoding scheme based on the node types of the paired nodes as well as its timing, and informs the other corresponding nodes, e.g., IAB₄. In another example, the transmitting nodes are IAB₁ and IAB₃. In this example, IAB₂ selects power-domain NOMA and sends signals to IAB₁ and IAB₃ to provide information for configuration of/request the appropriate transmit power and the allocated time/frequency resources (and optionally beam) based on the selected power-domain NOMA. IAB₂ adapts its decoding scheme based on the node types of the paired nodes as well as its timing, and informs the other corresponding nodes, e.g., IAB₄.

Considering the above description, the following example (and non-limiting) embodiments are envisioned. In one embodiment, with the IAB node 304-i (e.g., IAB₂ in FIG. 7) being a candidate to receive signals simultaneously from two transmitting nodes, the IAB node 304-i obtains the node types of the two transmitting nodes (i.e., if they are UE or IAB) as well as their power level/adaptation capability. In addition, the IAB node 304-i obtains the received signal powers for the two transmitting nodes at the IAB node 304-i. Then, depending on obtained information, the IAB node 304-i does the following:
(IAB, IAB) pair: If the two transmitting nodes are two IAB nodes (e.g., IAB₁ and IAB₃ in FIG. 7) and the gain of NOMA-based data transmission is high enough (e.g., greater than a predefined or preconfigured threshold gain which indicates that power-domain NOMA performs better than other OMA schemes), the IAB node 304-i uses a new signaling method and informs them to use, e.g., power-domain NOMA. This is because power-domain NOMA gives remarkably better performance, compared to non-power-domain NOMA. Also, based on the channels' qualities, the IAB node 304-i determines the appropriate transmit power level, beamforming, etc. of the transmitting nodes and informs them correspondingly such that, possibly, they adapt their transmission parameters based on the received information. Note that the gain of NOM-based data transmission schemes is well-known by those of skill in the art. However, for a review, the interested reader is directed to, e.g., P. Xu, Z. Ding, X. Dai, H. V. Poor, NOMA: An information theoretic perspective, arXiv: 1504.07751, 2015 available at: https://arxiv.org/abs/1504.07751.
(IAB, UE) pair: If one transmitting nodes is an IAB and the other transmitting node is a UE, the IAB node 304-i first makes sure if simultaneous reception is allowed. This is determined by exploiting the information about the node type and/or capabilities of the transmitting nodes, the received signal powers for the transmitting nodes as the IAB node 304-i, as well as the characteristics of the receiver of the IAB node 304-i. The reasons that the simultaneous reception may not be allowed are, e.g.: 1) the presence of UE may affect the successful decoding probability of the IAB signal considerably, or 2) due to hardware limitations, such as a limited Analog-to-Digital Converter (ADC) dynamic range, etc., when the received power of the signals of the IAB and UE are very different. For instance, consider an IAB node and a cell-edge UE. In this case, the low-SNR signal may be lost at the receiver before reaching the decoder. Based on this evaluation, the IAB node does the following:
   If simultaneous reception is allowed for this (IAB,UE) pair (for instance, in the cases with a cell-center UE and an IAB node), the IAB node 304-i considers a non-power-domain NOMA scheme, such as WSMA, MUSA, etc., and informs the paired nodes correspondingly. This is because the UEs may not have the same power allocation capability and output power accuracy as IAB nodes and, consequently, power-domain NOMA may not be possible to use. Then, depending on the selected non-power-domain NOMA approach, the IAB node 304-i may provide the paired IAB and UE nodes with their appropriate data transmission configuration. For instance, with WSMA, the IAB node 304-i may provide the paired IAB node and UE with their appropriate signature vectors (see Makki, Section II] for the details of WSMA).
   If simultaneous reception is not allowed (for instance in the cases with a cell-edge UE), the IAB and UE may be scheduled in different time slots instead.
(UE,UE) pair: With two UEs requesting for simultaneous transmission, the IAB node 304-i may select the non-power-domain NOMA (or other FDMA, TDMA, or SDMA scheme), and informs the UEs to adapt their data transmission method correspondingly.

To highlight the adaptation method based on the nodes' types/capabilities, the setup for the cases with different NOMA schemes has been explained. This is based on the assumption that, for given channel conditions, NOMA outperforms the other alternative multiple access schemes. However, this is not necessary and, depending on the channel conditions etc., one may select to serve the transmitting nodes by, e.g., FDMA, TDMA, or SDMA. Thus, for some of the conditions presented above, one transmission technique is preferred and, for other conditions, another transmission technique is preferred.

In one embodiment, upon receiving the control message(s) from the IAB node 304-i, the transmitting nodes may adapt their data transmission scheme and transmit the signals with the desired transmit parameters.

In another embodiment, based on the selected simultaneous reception scheme, the IAB node 304-i adapts it signal decoding scheme accordingly. For instance, with a non-power domain WSMA NOMA scheme, the same multiuser detector methods as in Multi-User Multiple Input Multiple Output (MU-MIMO) may be used by the IAB node 304-i. On the other hand, with power-domain NOMA, the IAB node 304-i uses Successive Interference Cancellation (SIC) based receivers. Finally, without simultaneous reception, the IAB node 304-i does not need to adapt it decoding method.

In one embodiment, depending on the selected simultaneous reception and data decoding scheme (with different decoding delays), the IAB node 304-i may adapt its timing and inform the nodes in the next hops, e.g., IAB₄ in FIG. 7, accordingly.

In this way, the proposed scheme improves the data transmission efficiency, reduces the data transmission delay, and guarantees that the weak signals are not lost during joint reception. Consequently, the E2E network throughput will be improved. Also, considering the proposed scheme, it is interesting to note that:
The setup for the cases with two transmitting nodes requesting for simultaneous transmission to an IAB node is sometimes described herein. However, the same approach is applicable for the cases with arbitrary number of transmitting nodes.
The proposed scheme is applicable for both uplink and downlink transmissions as well as their combination.
Cases where, depending on the types of the paired nodes, the multiple access scheme is switched between the power-domain and non-power-domain NOMA schemes. However, this is not necessary, and the adaptation may be between other multiple access schemes.
The presented example setup assumes that the IAB node is responsible for scheduling of all transmitter nodes. It may equally be that one of the IAB nodes as a parent node has instructed the IAB node to receive at one point in time, and the IAB node schedules one or more other nodes in the same spectrum, taking into account the resources that are scheduled by the parent node.

FIG. 8 is a schematic block diagram of an IAB node 800 according to some embodiments of the present disclosure. Optional features are represented by dashed boxes. The IAB node 800 may be, for example, one of the IAB nodes 304-1 through 304-N described herein or the IAB donor 302 described herein. As illustrated, the IAB node 800 includes a control system 802 that includes one or more processors 804 (e.g., Central Processing Units (CPUs), Application Specific Integrated Circuits (ASICs), Field Programmable Gate Arrays (FPGAs), and/or the like), memory 806, and optionally a network interface 808. The one or more processors 804 are also referred to herein as processing circuitry. In addition, the IAB node 800 includes one or more radio units 810 that each includes one or more transmitters 812 and one or more receivers 814 coupled to one or more antennas 816. The radio units 810 may be referred to or be part of radio interface circuitry. In some embodiments, the radio unit(s) 810 is external to the control system 802 and connected to the control system 802 via, e.g., a wired connection (e.g., an optical cable). However, in some other embodiments, the radio unit(s) 810 and potentially the antenna(s) 816 are integrated together with the control system 802. The one or more processors 804 operate to provide one or more functions of the IAB node 800 as described herein (e.g., one or more functions of a parent IAB node, such as the parent IAB node 304-p, or an IAB node, such as the IAB node 304-i, or a child IAB node, such as the child IAB node 304-c, as described above, e.g., with respect to FIG. 4, 5, 6, or 7). In some embodiments, the function(s) are implemented in software that is stored, e.g., in the memory 806 and executed by the one or more processors 804.

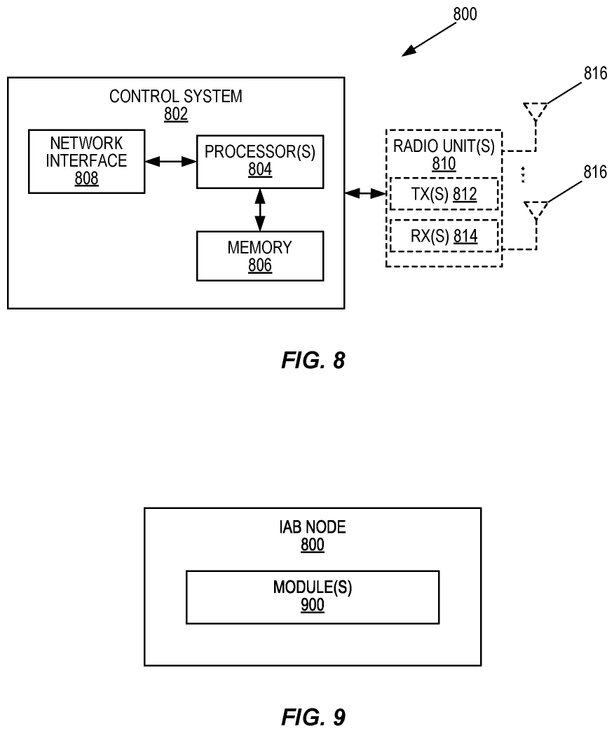

FIG. 9 is a schematic block diagram of the IAB node 800 according to some other embodiments of the present disclosure. The IAB node 800 includes one or more modules 900, each of which is implemented in software. The module(s) 900 provide the functionality of the IAB node 800 described herein (e.g., one or more functions of a parent IAB node, such as the parent IAB node 304-p, or an IAB node, such as the IAB node 304-i, or a child IAB node, such as the child IAB node 304-c, as described above, e.g., with respect to FIG. 4, 5, 6, or 7).

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method performed by an Integrated Access and Backhaul (IAB) node, the method comprising:
obtaining channel quality or received signal power for each of two or more transmitting nodes at the IAB node;
selecting, based on the channel qualities or received signal powers for the two or more transmitting nodes, a combination of scheduling configurations for the two or more transmitting nodes, the combination of scheduling configurations comprising a multiple access scheme for the two or more transmitting nodes selected from a set of multiple access schemes comprising one or more multiple access schemes that enable simultaneous reception of signals transmitted from the two or more transmitting nodes at the IAB node and one or more multiple access schemes that enable non-simultaneous reception of signals transmitted from the two or more transmitting nodes at the IAB node;
transmitting one or more messages to the two or more transmitting nodes that provide information for configuration of or request the two or more transmitting nodes to transmit signals to the IAB node in accordance with the selected multiple access scheme; and
receiving signals from the two or more transmitting nodes in accordance with the selected multiple access scheme.

2. The method of claim 1, wherein the one or more multiple access schemes that enable simultaneous reception of transmissions from the two or more nodes at the IAB node comprise one or more non-orthogonal multiple access (NOMA) schemes.

3. The method of claim 2, wherein the one or more NOMA schemes comprise one or more power-domain NOMA schemes.

4. The method of claim 2, wherein the one or more NOMA schemes comprise one or more non-power-domain NOMA schemes.

5. The method of claim 2, wherein the one or more multiple access schemes that enable simultaneous reception of transmissions from the two or more nodes at the IAB node further comprise one or more Orthogonal Multiple Access (OMA) schemes.

6. The method of claim 5, wherein the one or more OMA schemes comprise: a Spatial Division Multiple Access (SDMA) scheme, a Frequency Division Multiple Access (FDMA) scheme, or both the SDMA scheme and the FDMA scheme.

7. The method of claim 1, wherein the one or more multiple access schemes that enable non-simultaneous reception of transmissions from the two or more nodes at the IAB node comprise one or more orthogonal multiple access (OMA) schemes that enable non-simultaneous reception.

8. The method of claim 7, wherein the one or more OMA schemes that enable non-simultaneous reception comprise a Time Division Multiple Access scheme.

9. The method of claim 1, wherein the two or more transmitting nodes consist of two or more child IAB nodes of the IAB node.

10. The method of claim 1, wherein the two or more transmitting nodes consist of two or more wireless communications devices served by the IAB node.

11. The method of claim 1, wherein the two or more transmitting nodes consist of one or more child IAB nodes of the IAB node and one or more wireless communications devices served by the IAB node.

12. The method of claim 1, wherein the two or more transmitting nodes consist of:
a parent IAB node of the IAB node; and
either one or more child IAB nodes of the IAB node, one or more wireless communications devices served by the IAB node, or both.

13. The method of claim 1, wherein:
selecting the combination of scheduling configurations for the two or more transmitting nodes comprises selecting the multiple access scheme for the two or more transmitting nodes from the set of multiple access schemes based on the channel qualities or received signal powers for the two or more transmitting nodes at the IAB node.

14. The method of claim 1, wherein:
selecting the combination of scheduling configurations for the two or more transmitting nodes comprises selecting the multiple access scheme for the two or more transmitting nodes from the set of multiple access schemes based on the received signal powers for the two or more transmitting nodes at the IAB node and a dynamic range of a receiver of the IAB node.

15. The method of claim 14, wherein selecting the multiple access scheme for the two or more transmitting nodes comprises:
determining, based on the received signal powers for the two or more transmitting nodes at the IAB node, whether a combined signal that would result from simultaneous reception of signals from the two or more transmitting nodes at the receiver of the IAB node would exceed the dynamic range of the receiver of the IAB node; and
responsive to determining that a combined signal that would result from simultaneous reception of signals from the two or more transmitting nodes at the receiver of the IAB node would not exceed the dynamic range of the receiver of the IAB node, selecting either a power-domain non-orthogonal multiple access (NOMA) scheme or a non-power-domain NOMA scheme as the multiple access scheme for the two or more transmitting nodes.

16. The method of claim 15, wherein selecting either a power-domain NOMA scheme or a non-power-domain NOMA scheme as the multiple access scheme for the two or more transmitting nodes comprises:
determining whether a difference in received signal power for the two or more transmitting nodes is greater than a predefined or preconfigured threshold for power-domain NOMA;
responsive to determining that the difference in received signal power for the two or more transmitting nodes is greater than the predefined or preconfigured threshold for power-domain NOMA, selecting a power-domain NOMA scheme as the multiple access scheme for the two or more transmitting nodes.

17. The method of claim 15, wherein selecting either a power-domain NOMA scheme or a non-power-domain NOMA scheme as the multiple access scheme for the two or more transmitting nodes comprises:
determining whether a difference in received signal power for the two or more transmitting nodes is greater than a predefined or preconfigured threshold for power-domain NOMA;
responsive to determining that the difference in received signal power for the two or more transmitting nodes is not greater than the predefined or preconfigured threshold for power-domain NOMA, selecting a non-power-domain NOMA scheme as the multiple access scheme for the two or more transmitting nodes.

18.-19. (canceled)

20. The method of claim 13, wherein selecting the multiple access scheme for the two or more transmitting nodes comprises:
determining whether the two or more transmitting nodes are IAB nodes;
responsive to determining that the two or more transmitting nodes are IAB nodes:
determining whether a gain of NOMA-based transmission for the two or more transmitting nodes exceeds a predefined or preconfigured threshold; and
responsive to determining that the gain of NOMA-based transmission for the two or more transmitting nodes exceeds the predefined or preconfigured threshold, selecting a power-domain NOMA scheme as the multiple access scheme for the two or more transmitting nodes.

21. The method of claim 13, wherein selecting the multiple access scheme for the two or more transmitting nodes comprises:
determining whether the two or more transmitting nodes are IAB nodes;
responsive to determining that the two or more transmitting nodes are IAB nodes:
determining whether a gain of NOMA-based transmission for the two or more transmitting nodes exceeds a predefined or preconfigured threshold; and
responsive to determining that the gain of NOMA-based transmission for the two or more transmitting nodes does not exceed the predefined or preconfigured threshold, selecting a multiple access scheme other than a power-domain NOMA scheme as the multiple access scheme for the two or more transmitting nodes.

22.-26. (canceled)

27. An Integrated Access and Backhaul (IAB) node comprising:
one or more radio units; and
processing circuitry associated with the one or more radio units, the processing circuitry configured to cause the IAB node to:
obtain channel quality or received signal power for each of two or more transmitting nodes at the IAB node;
select, based on the channel qualities or received signal powers for the two or more transmitting nodes, a combination of scheduling configurations for the two or more transmitting nodes, the combination of scheduling configurations comprising a multiple access scheme for the two or more transmitting nodes selected from a set of multiple access schemes comprising one or more multiple access schemes that enable simultaneous reception of signals transmitted from the two or more transmitting nodes at the IAB node and one or more multiple access schemes that enable non-simultaneous reception of signals transmitted from the two or more transmitting nodes at the IAB node;
transmit one or more messages to the two or more transmitting nodes that provide information for configuration of or request the two or more transmitting nodes to transmit signals to the IAB node in accordance with the selected multiple access scheme; and
receive signals from the two or more transmitting nodes in accordance with the selected multiple access scheme.

28. (canceled)
